(19) United States
(12) Patent Application Publication
(10) Pub. No.: US 2023/0245352 A1
(43) Pub. Date: Aug. 3, 2023

(54) IMAGE GENERATION METHOD AND IMAGE DISPLAY APPARATUS

(71) Applicant: SEIKO EPSON CORPORATION, Tokyo (JP)

(72) Inventor: Kiichiro GOTO, Oita-Shi (JP)

(21) Appl. No.: 18/162,740

(22) Filed: Feb. 1, 2023

(30) Foreign Application Priority Data
Feb. 1, 2022 (JP) 2022-014169

(51) Int. Cl. G06T 11/00; G06T 7/00; H04N 5/272

(52) U.S. Cl. CPC G06T 11/00; G06T 7/97; H04N 5/272; G06T 2210/62; G06T 2207/10016; G06T 2207/30221; H04N 9/3179

(57) ABSTRACT

An image generation method includes acquiring a first image that is the image of a first frame, acquiring a second image that is the image of a second frame following the first frame, and generating a first superimposed image that is the result of superposition of the first image and the second image.

The present application is based on, and claims priority from JP Application Serial Number 2022-014169, filed Feb. 1, 2022, the disclosure of which is hereby incorporated by reference herein in its entirety.

### BACKGROUND

### 1. Technical Field

The present disclosure relates to an image generation method and an image display apparatus.

### 2. Related Art

JP-A-2005-288014 discloses a technology for displaying a plurality of still images arranged in chronological order based on video data produced by capturing images of a player who is playing a sport such as golf.

According to the technology disclosed in JP-A-2005-288014, a golf player's swing form, for example, can be visually evaluated. However, when a plurality of still images are displayed side by side in a single screen, as in the technology disclosed in JP-A-2005-288014, it is difficult to visually capture small changes that appear in the form of the golf player, which is a dynamically moving object under evaluation, because the still images each have a small size.

### SUMMARY

An image generation method according to an aspect of the present disclosure includes acquiring a first image that is an image of a first frame, acquiring a second image that is an image of a second frame following the first frame, and generating a first superimposed image that is a result of superposition of the first image and the second image.

An image display apparatus according to another aspect of the present disclosure includes a display unit that displays an image, and a processor that controls the display unit, and the processor generates the first superimposed image described above by executing the image generation method according to the aspect described above, and causes the display unit to display the first superimposed image.

### BRIEF DESCRIPTION OF THE DRAWINGS

FIG. 1 is a block diagram showing a schematic configuration of an image display apparatus according to an embodiment of the present disclosure.

FIG. 2 is a flowchart showing processes executed by a processor after the image display apparatus is powered on.

FIG. 3 is a first flowchart showing processes executed by the processor when the processor transitions to a superimposed display mode.

FIG. 4 is a flowchart showing a first superimposed image generation process executed by the processor.

FIG. 5 shows an example of a first image acquired by the processor.

FIG. 6 shows an example of a second image acquired by the processor.

FIG. 7 shows an example of a first superimposed image generated by the processor through execution of the first superimposed image generation process.

FIG. 8 is a flowchart showing a second superimposed image generation process executed by the processor.

FIG. 9 shows an example of the first superimposed image generated by the processor through execution of the second superimposed image generation process.

FIG. 10 is a second flowchart showing processes executed by the processor when the processor transitions to the superimposed display mode.

FIG. 11 is a flowchart showing a third superimposed image generation process executed by the processor.

FIG. 12 shows an example of a third image acquired by the processor.

FIG. 13 shows an example of a second superimposed image generated by the processor through execution of the third superimposed image generation process.

FIG. 14 is a flowchart showing a fourth superimposed image generation process executed by the processor.

FIG. 15 shows an example of the second superimposed image generated by the processor through execution of the fourth superimposed image generation process.

### DESCRIPTION OF EXEMPLARY EMBODIMENTS

Embodiments of the present disclosure will be described below with reference to the drawings.

In the following drawings, components may be drawn at different dimensional scales for clarification of each of the components.

### First Embodiment

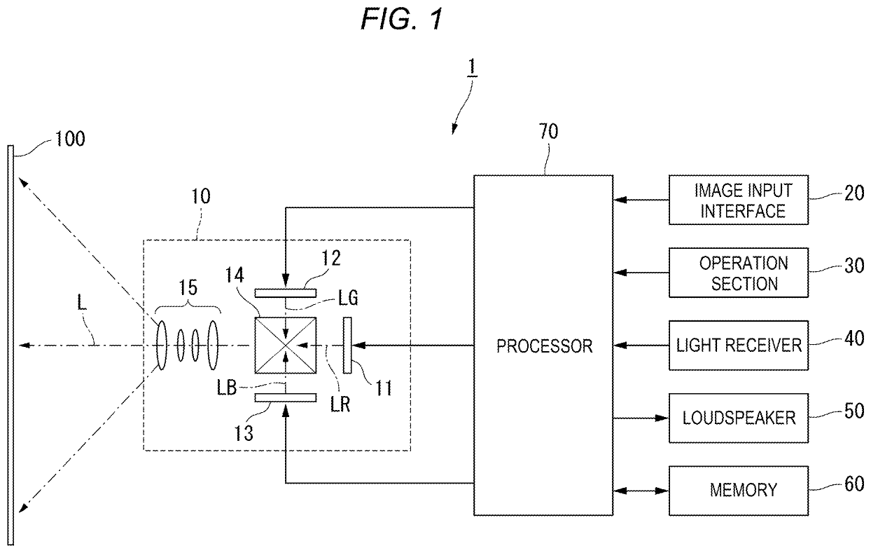

A first embodiment will first be described. FIG. 1 is a block diagram showing a schematic configuration of an image display apparatus 1 according to the first embodiment. The image display apparatus 1 includes a display unit 10, a video input interface 20, an operation section 30, a light receiver 40, a loudspeaker 50, a memory 60, and at least one processor 70, as shown in FIG. 1. The image display apparatus 1 is a projector that displays an image on a projection surface 100 by projecting image light L onto the projection surface 100. The projection surface 100 may be a dedicated projector screen, a wall surface, or any other surface.

The display unit 10 displays an image under the control of the processor 70. More specifically, the display unit 10 generates the image light L representing a color image and project the image light L onto the projection surface 100 under the control of the processor 70. The display unit 10 includes a first image generation panel 11, a second image generation panel 12, a third image generation panel 13, a dichroic prism 14, and a projection system 15.

The first image generation panel 11 generates red image light LR, which represents a red image, and outputs the red image light LR to the dichroic prism 14. The first image generation panel 11 includes a plurality of pixels arranged in a matrix, and the plurality of pixels each output red light. The red image light LR is outputted from the first image generation panel 11 as a result of control performed by the processor 70 on the amount of the outputted red light on a pixel basis.

The second image generation panel 12 generates green image light LG, which represents a green image, and outputs the green image light LG to the dichroic prism 14. The second image generation panel 12 includes a plurality of pixels arranged in a matrix, and the plurality of pixels each output green light. The green image light LG is outputted from the second image generation panel 12 as a result of control performed by the processor 70 on the amount of the outputted green light on a pixel basis.

The third image generation panel 13 generates blue image light LB, which represents a blue image, and outputs the blue image light LB to the dichroic prism 14. The third image generation panel 13 includes a plurality of pixels arranged in a matrix, and the plurality of pixels each output blue light. The blue image light LB is outputted from the third image generation panel 13 as a result of control performed by the processor 70 on the amount of the outputted blue light on a pixel basis.

For example, the first image generation panel 11, the second image generation panel 12, and the third image generation panel 13 are each a self-luminous electro-optical device, such as an organic light emitting diode (OLED) panel and a micro light emitting diode (μLED) panel, or a non-self-luminous electro-optical device, such as a liquid crystal panel and a digital micromirror device (DMD).

The dichroic prism 14 combines the red image light LR, the green image light LG, and the blue image light LB with one another to generate the image light L representing a color image and outputs the image light L to the projection system 15. The projection system 15 is formed of a plurality of optical elements, such as lenses, and enlarges and projects the image light L that exits out of the dichroic prism 14 onto the projection surface 100. A color image visually recognizable by a user is thus projected on the projection surface 100.

The video input interface 20 is an interface that supports a plurality of communication standards, such as HDMI (high-definition multimedia interface, registered trademark), DVI (digital visual interface), and USB (universal serial bus). Specifically, the image display apparatus 1 is provided with input terminals, such as an HDMI terminal, a DVI terminal, and a USB terminal, and the video input interface 20 converts a video signal inputted via any of the input terminals into a signal that can be processed by the processor 70 and outputs the converted signal to the processor 70. The video signal includes an image signal, an audio signal, and a control signal.

The operation section 30 is formed of a plurality of operation keys provided as part of the image display apparatus 1. For example, the operation keys include a power key, a menu activation key, a cross-shaped key, a finalizing key, and a volume adjustment key. The operation keys may be hardware keys, or software keys displayed on a touch panel. The operation section 30 outputs an electric signal generated by the user through operation of any of the operation keys to the processor 70 as an operation signal.

The light receiver 40 includes a photoelectric conversion circuit that receives infrared light transmitted from a remote control (not shown) associated with the image display apparatus 1 and converts the infrared light into an electric signal. The light receiver 40 outputs the electric signal produced by the photoelectric conversion of the infrared light to the processor 70 as a remote operation signal. The remote control is provided with a plurality of operation keys, as the operation section 30 is. The remote control converts an electric signal produced when the user operates any of the operations key provided as part of the remote control into infrared light and transmits the infrared light to the image display apparatus 1. That is, the remote operation signal outputted from the light receiver 40 is substantially the same as the electric signal produced when the user operates any of the operations key of the remote control. When the remote control transmits a radio signal in accordance with a short-range wireless communication standard, such as Bluetooth (registered trademark), a receiver device that receives the radio signal may be provided in place of the light receiver 40.

The loudspeaker 50 outputs audio having predetermined volume under the control of the processor 70. The memory 60 includes a nonvolatile memory that stores a program and a variety of setting data necessary for the processor 70 to execute a variety of processes, and a volatile memory used as a temporary data saving destination when the processor 70 executes the variety of processes. The nonvolatile memory is, for example, an EEPROM (electrically erasable programmable read-only memory) or a flash memory. The volatile memory is, for example, a RAM (random access memory).

The processor 70 is an arithmetic processing device that controls the overall action of the image display system 1 in accordance with the program stored in the memory 60 in advance. The processor 70 is formed of one or more CPUs (central processing units) by way of example. Part or entirety of the functions of the processor 70 may be achieved, for example, by a DSP (digital signal processor), an ASIC (application specific integrated circuit), a PLD (programmable logic device), or an FPGA (field programmable gate array). The processor 70 concurrently or successively performs the variety of processes. Specifically, the processor 70 controls the display unit 10 and the loudspeaker 50 based on the operation signal inputted from the operation section 30, the remote operation signal inputted from the light receiver 40, and the video signal inputted from the video input interface 20.

The action of the image display apparatus 1 configured as described above will next be described.

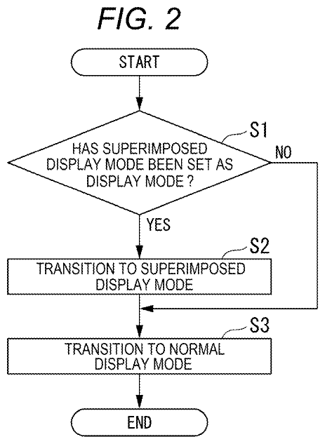

FIG. 2 is a flowchart showing a display mode setting process executed by the processor 70 after the image display apparatus 1 is powered on. The processor 70 reads the program from the memory 60 and executes the program to execute each of the processes shown in the flowchart of FIG. 2.

The processor 70 determines whether a superimposed display mode has been set as the display mode (step S1), as shown in FIG. 2. The superimposed display mode, although will be described later in detail, is a mode in which the processor 70 generates a superimposed image by superimposing images of a plurality of frames contained in the video signal inputted from an external apparatus via the video input interface 20 and causes the display unit 10 to display the generated superimposed image. The superimposed display mode may be “enabled” as the default, or may be “enabled” at any timing by the user through operation of the operation section 30 or the remote control.

When the processor 70 determines that the superimposed display mode has been set as the display mode, that is, the superimposed display mode has been “enabled” (Yes step in S1), the processor 70 transitions to the superimposed display mode (Step S2). The action of the processor 70 in the superimposed display mode will be described later.

On the other hand, when the processor 70 determines that the superimposed display mode has not been set as the display mode, that is, the superimposed display mode has not been “enabled” (No in step S1), the processor 70 transitions to a normal display mode (Step S3). Even after the processor 70 transitions to the superimposed display mode, the processor 70 transitions to the normal display mode after the superimposed display mode is terminated. The normal display mode is a mode in which the processor 70 controls the display unit 10 based on the video signal inputted from an external apparatus via the video input interface 20 to display a video based on the video signal, such as still images or motion images, on the projection surface 100. The action in the normal display mode is generally known as a function of a projector and will therefore not described in the present embodiment.

The action of the processor 70 in the superimposed display mode will be described below.

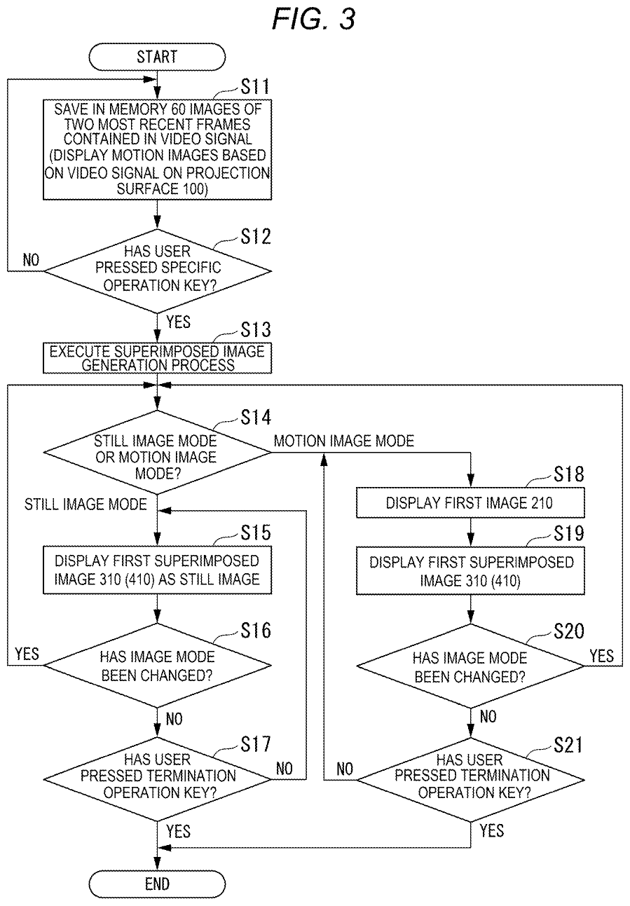

FIG. 3 is a flowchart showing processes executed by the processor 70 when the processor 70 transitions to the superimposed display mode. The processor 70 reads the program from the memory 60 and executes the program to execute each of the processes shown in the flowchart of FIG. 3. A method for controlling the image display apparatus 1 according to the first embodiment is realized by the processor 70 through execution of each of the processes shown in the flowchart of FIG. 3.

When the processor 70 transitions to the superimposed display mode, the processor 70 saves in the memory 60 the images of a plurality of most recent frames contained in the inputted video signal (step S11), as shown in FIG. 3. The first embodiment will be described with reference by way of example to a case where the processor 70 saves in the memory 60 the images of two most recent frames contained in the video signal.

Specifically, the processor 70 first sequentially saves in the memory 60 the image of the first frame and the image of the second frame out of the frames chronologically contained in the video signal. The sentence “the processor 70 saves the image of the n-th (n is integer greater than or equal to one) frame in the memory 60” means that the processor 70 saves image data representing the image of the n-th frame in the memory 60.

The processor 70 then sequentially saves in the memory 60 the images of the fourth and fifth frames out of the frames chronologically contained in the video signal. At this point, the images of the first and second frames saved in the memory 60 are sequentially deleted. After the processor 70 repeats the processes described above, the memory 60 saves the images of the two most recent frames out of the frames chronologically contained in the video signal.

In step S11, the processor 70 controls the display unit 10 based on the video signal while saving in the memory 60 the images of the two most recent frames contained in the video signal. Motion images based on the video signal are thus displayed on the projection surface 100. As an example, assume that the motion images displayed on the projection surface 100 show that an athlete P who participates a short-distance running race, which is a track and field event, competes in the 100-meter race. In this case, the user of the image display apparatus 1 may, for example, be a coach or a manager for the short-distance running race. While viewing the motion images displayed on the projection surface 100, the user searches for a scene in which the user desires to check the form of the athlete P, which is a dynamically moving object under evaluation, and when the user locates the scene, the user presses a specific operation key out of the plurality of operation keys provided on the operation section 30 or the remote control. The specific operation key is an operation key that instructs the processor 70 to execute a superimposed image generation process, which will be described later.

After the processor 70 saves in the memory 60 the images of the two most recent frames contained in the video signal, the processor 70 determines whether the user has pressed the specific operation key based on the operation signal inputted from the operation section 30 or the remote operation signal inputted from the light receiver 40 (step S12). When the processor 70 determines that the user has not pressed the specific operation key (No in step S12), the processor 70 returns to step S11 and saves in the memory 60 the images of the next two most recent frames contained in the video signal.

On the other hand, when the processor 70 determines that the user has pressed the specific operation key (Yes in step S12), the processor 70 stops saving the images of the two most recent frames in the memory 60 and displaying the motion images based on the video signal, and then executes the superimposed image generation process, which will be described later (step S13). In step S13, the processor 70 executes the superimposed image generation process of generating a superimposed image by superimposing the images of the two most recent frames saved in the memory 60. The image generation method according to the first embodiment is realized by the processor 70 through execution of the superimposed image generation process.

The superimposed image generation processes executed by the processor 70 will be described below with reference to two cases: a first superimposed image generation process; and a second superimposed image generation process. The processor 70 may execute one of the two superimposed image generation processes. Instead, the program may be so configured that the user can select one of the two superimposed image generation processes by operating the operation section 30 or the remote control. In this case, the processor 70 executes the superimposed image generation process selected by the user out of the two superimposed image generation processes based on the operation signal inputted from the operation section 30 or the remote operation signal inputted from the light receiver 40.

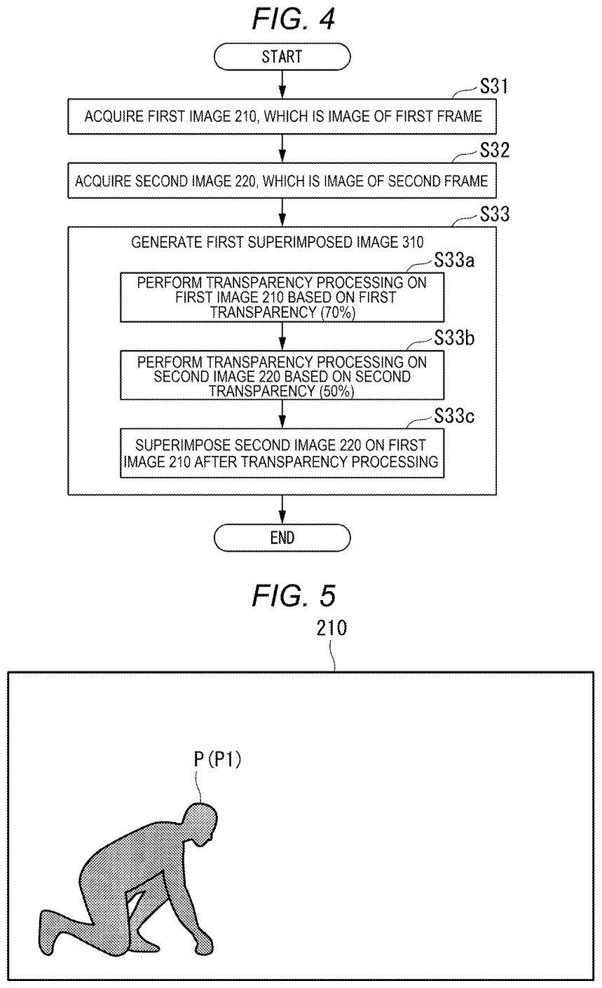

FIG. 4 is a flowchart showing the first superimposed image generation process executed by the processor 70. The processor 70 reads the program from the memory 60 and executes the program to execute the first superimposed image generation process shown in the flowchart of FIG. 4.

The processor 70 acquires a first image 210, which is the image of a first frame (step S31), as shown in FIG. 4. Specifically, in step S31, the processor 70 acquires the image of the oldest frame out of the images of the two most recent frames saved in the memory 60 as “the first image 210, which is the image of the first frame”. Note that “the processor 70 acquires the first image 210” means that the processor 70 reads image data representing the first image 210 from the memory 60.

FIG. 5 shows an example of the first image 210 acquired by the processor 70. The first image 210 is an image showing the short-distance-running athlete P who is stationary in a crouch start posture, as shown in FIG. 5. In the following description, an image of the athlete P contained in the first image 210 is referred to as a “first athlete image P1” in some cases.

The processor 70 subsequently acquires a second image 220, which is the image of a second frame following the first frame 220 (step S32). Specifically, in step S32, the processor 70 acquires the image of the newest frame out of the images of the two most recent frames saved in the memory 60 as “the second image 220, which is the image of the second frame”. Note that “the processor 70 acquires the second image 220” means that the processor 70 reads image data representing the second image 220 from the memory 60.

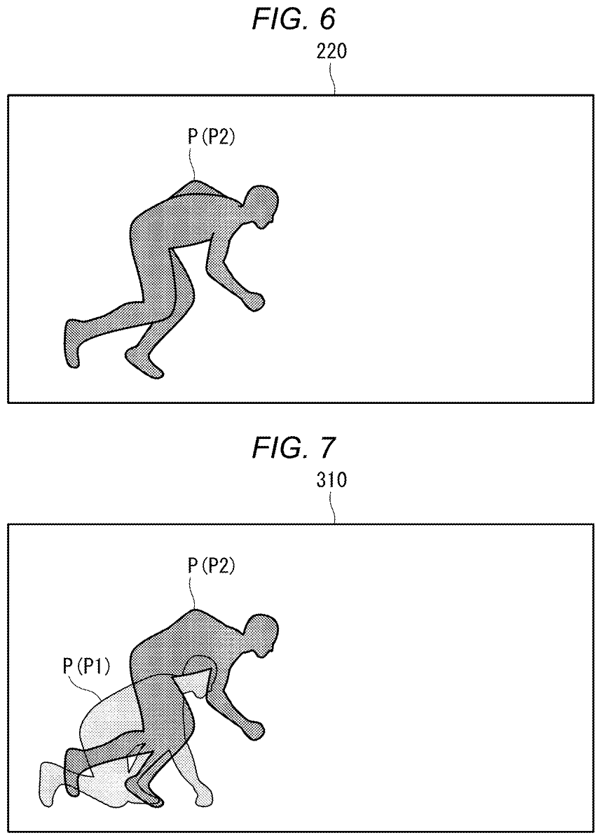

FIG. 6 shows an example of the second image 220 acquired by the processor 70. The second image 220 is an image showing the moment when the athlete P starts charging out at full speed from the crouch start posture, as shown in FIG. 6. In other words, the second image 220 is an image showing the posture of the athlete P who starts charging out at full speed. In the following description, an image of the athlete P contained in the second image 220 is referred to as a “second athlete image P2” in some cases.

The processor 70 subsequently generates a first superimposed image 310, which is the result of superposition of the first image 210 and the second image 220 (step S33). Step S33 includes three steps, step S33a, step S33b, and step S33c. When the processor 70 transitions to step S33, the processor 70 first generates a first transparent image by performing transparency processing on the first image 210 based on first transparency (step S33a). In the first superimposed image generation process, the first transparency is set in advance at a predetermined value. The first transparency is set at 70% by way of example. The transparency processing is a commonly known process in the field of image processing and will therefore be not described in the present specification. The first image 210 on which the transparency processing has been performed based on the first transparency corresponds to the first transparent image.

The processor 70 then generates a second transparent image by performing the transparency processing on the second image 220 based on second transparency different from first transparency (step S33b). Specifically, in step S33b, the processor 70 performs the transparency processing on the second image 220 based on the second transparency lower than the first transparency. In the first superimposed image generation process, the second transparency is set in advance at a predetermined value. The second transparency is set at 50% by way of example. The second image 220 on which the transparency processing has been performed based on the second transparency corresponds to the second transparent image.

After performing the transparency processing on the first image 210 and the second image 220, the processor 70 then superimposes the first image 210 and the second image 220 on each other to generate the first superimposed image 310 (step S33c). That is, in step S33c, the processor 70 generates the first superimposed image 310 by superimposing the first transparent image and the second transparent image on each other. Specifically, after performing the transparency processing on the first image 210 and the second image 220, the processor 70 superimposes the second image 220 on the first image 210 in step S33c. That is, the processor 70 superimposes the second transparent image on the first transparent image.

FIG. 7 shows an example of the first superimposed image 310 generated by the processor 70 through execution of the first superimposed image generation process. As described above, the processor 70 generates the first superimposed image 310 by superimposing the second image 220 on which the transparency processing has been performed at the second transparency of 50% on the first image 210 on which the transparency processing has been performed at the first transparency of 70%. The first superimposed image 310, which contains the first athlete image P1 having relatively light shading and the second athlete image P2 superimposed on the first athlete image P1 and having shading darker than that of the first athlete image P1, is thus generated, as shown in FIG. 7.

The first superimposed image generation process executed by the processor 70 has been described. As clearly described above, the image generation method realized by the processor 70 through execution of the first superimposed image generation process includes acquiring the first image 210 (step S31), which is the image of the first frame, acquiring the second image 220 (step S32), which is the image of the second frame following the first frame, and generating the first superimposed image 310 (step S33), which is the result of superimposition of the first image 210 and the second image 220.

Generating the first superimposed image 310 (step S33) further includes generating the first transparent image by performing the transparency processing on the first image 210 based on the first transparency (step S33a), generating the second transparent image by performing the transparency processing on the second image 220 based on the second transparency different from the first transparency (step S33b), and superimposing the first transparent image and the second transparent image on each other (step S33c).

More specifically, the image generation method according to the first embodiment further includes performing the transparency processing on the second image 220 based on the second transparency lower than the first transparency (step S33b), and superimposing the second transparent image over the first transparent image (step S33c).

The second superimposed image generation process executed by the processor 70 will be described below.

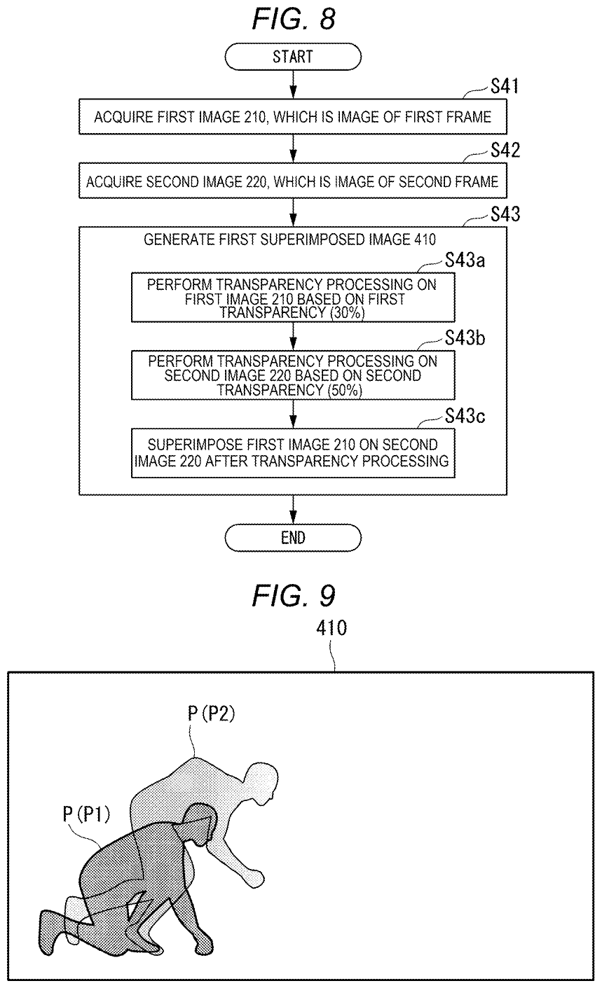

FIG. 8 is a flowchart showing the second superimposed image generation process executed by the processor 70. The processor 70 reads the program from the memory 60 and executes the program to execute the second superimposed image generation process shown in the flowchart of FIG. 8. Among the steps contained in the second superimposed image generation process, the same steps as those in the first superimposed image generation process will be described in a simplified manner.

The processor 70 acquires the first image 210, which is the image of the first frame (step S41), as shown in FIG. 8. The processor 70 subsequently acquires the second image 220, which is the image of the second frame following the first frame (step S42).

The processor 70 subsequently generates a first superimposed image 410, which is the result of superposition of the first image 210 and the second image 220 (step S43). Step S43 includes three steps, step S43a, step S43b, and step S43c. When the processor 70 transitions to step S43, the processor 70 first generates a first transparent image by performing transparency processing on the first image 210 based on first transparency (step S43a). In the second superimposed image generation process, the first transparency is set in advance at a predetermined value. The first transparency is set at 30% by way of example.

The processor 70 then generates a second transparent image by performing the transparency processing on the second image 220 based on second transparency different from first transparency (step S43b). Specifically, in step S43b, the processor 70 performs the transparency processing on the second image 220 based on the second transparency higher than the first transparency. In the second superimposed image generation process, the second transparency is set in advance at a predetermined value. The second transparency is set at 50% by way of example.

After the transparency processing has been performed on the first image 210 and the second image 220, the processor 70 superimposes the first image 210 and the second image 220 on each other to generate the first superimposed image 410 (step S43c). That is, in step S43c, the processor 70 generates the first superimposed image 410 by superimposing the first transparent image and the second transparent image on each other. Specifically, after the transparency processing has been performed on the first image 210 and the second image 220, the processor 70 superimposes the first image 210 on the second image 220 in step S43c. That is, the processor 70 superimposes the first transparent image on the second transparent image.

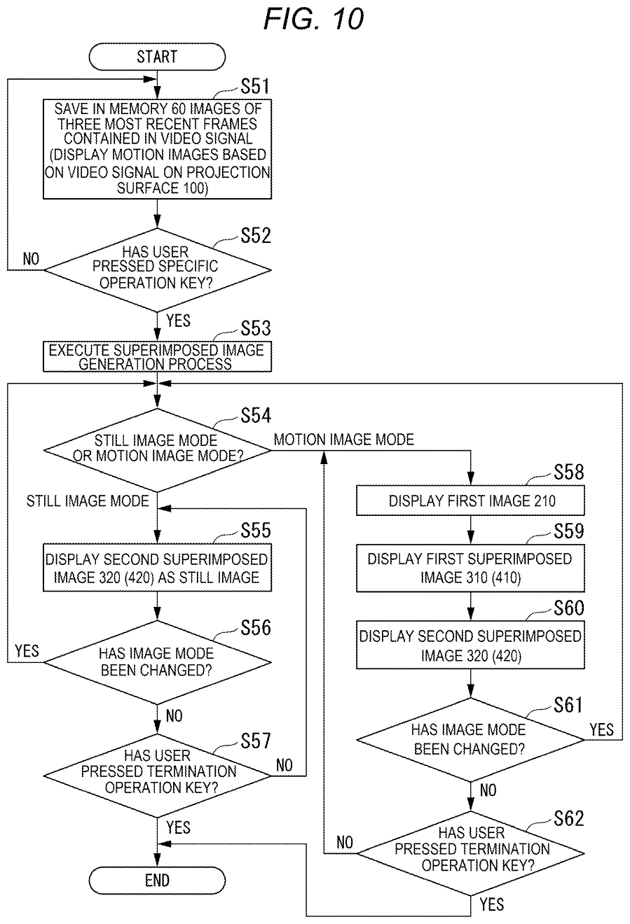

FIG. 9 shows an example of the first superimposed image 410 generated by the processor 70 through execution of the second superimposed image generation process. As described above, the processor 70 generates the first superimposed image 410 by superimposing the first image 210 on which the transparency processing has been performed at the first transparency of 30% lower than the second transparency on the second image 220 on which the transparency processing has been performed at the second transparency of 50% higher than the first transparency. The first superimposed image 410, which contains the second athlete image P2 having relatively light shading and the first athlete image P1 superimposed on the second athlete image P2 and having shading darker than that of the second athlete image P2, is thus generated, as shown in FIG. 9.

The second superimposed image generation process executed by the processor 70 has been described. As clearly described above, the image generation method realized by the processor 70 through execution of the second superimposed image generation process includes acquiring the first image 210 (step S41), which is the image of the first frame, acquiring the second image 220 (step S42), which is the image of the second frame following the first frame, and generating the first superimposed image 410 (step S43), which is the result of superimposition of the first image 210 and the second image 220.

Generating the first superimposed image 410 (step S43) further includes generating the first transparent image by performing the transparency processing on the first image 210 based on the first transparency (step S43a), generating the second transparent image by performing the transparency processing on the second image 220 based on the second transparency different from the first transparency (step S43b), and superimposing the first transparent image and the second transparent image on each other (step S43c).

More specifically, the image generation method according to the first embodiment further includes performing the transparency processing on the second image 220 based on the second transparency higher than the first transparency (step S43b), and superimposing the first transparent image on the second transparent image (step S43c).

The description will resume with reference back to the flowchart of FIG. 3. When the processor 70 terminates the first or second superimposed image generation process described above, the processor 70 transitions to step S14 in the flowchart of FIG. 3. When the processor 70 transitions to step S14, the processor 70 determines whether the image mode selected by the user is a still image mode or a motion image mode based on the operation signal inputted from the operation section 30 or the remote operation signal inputted from the light receiver 40 (step S14). The user can select one of the still image mode and the motion image mode by operating the operation keys provided on the operation section 30 or the remote control.

The action of the processor 70 in the still image mode will first be described.

When the processor 70 determines that the image mode selected by the user is the still image mode (still image mode in step S14), the processor 70 controls the display unit 10 to display the first superimposed image 310 generated by the first superimposed image generation process, or the first superimposed image 410 generated by the second superimposed image generation process on the projection surface 10 as a still image (step S15).

Specifically, in step S15, the processor 70 reads image data on the first superimposed image 310 or 410 as image data on each frame from the memory 60, and controls the display unit 10 based on the read image data to display the first superimposed image 310 or 410 as the image of each frame on the projection surface 100.

When the period for which the first superimposed image 310 or 410 has been displayed reaches a predetermined period, the processor 70 determines based on the operation signal inputted from the operation section 30 or the remote operation signal inputted from the light receiver 40 whether the image mode has been changed by the user (step S16). When the processor 70 determines that the image mode has been changed by the user (Yes in step S16), the processor 70 stops displaying the first superimposed image 310 or 410 as a still image and returns to step S14.

On the other hand, when the processor 70 determines that the image mode has not been changed by the user (No in step S16), the processor 70 determines whether the user has pressed a termination operation key (step S17). The termination operation key is an operation key that instructs the processor 70 to terminate the superimposed display mode.

When the processor 70 determines that the user has not pressed the termination operation key (No in step S17), the processor 70 returns to step S15 and keeps displaying the first superimposed image 310 or 410 as a still image. When the period for which the first superimposed image 310 or 410 has been displayed reaches the predetermined period again from the time when the processor 70 has returned to step S15, the processor 70 executes step S16. On the other hand, when the processor 70 determines that the user has pressed the termination operation key (Yes in step S17), the processor 70 stops displaying the first superimposed image 310 or 410 as a still image and terminates the superimposed display mode. The processor 70 terminates the superimposed display mode and transitions to the normal display mode (step S3), as shown in FIG. 2.

As described above, in the still image mode, unless the image mode is changed by the user, the first superimposed image 310 or 410 keeps being displayed as a still image on the projection surface 100 until the user presses the termination operation key. When the image mode is changed by the user during the still image mode, the image mode is switched to the motion image mode, which will be described later.

The action of the processor 70 in the motion image mode will next be described.

After executing the first superimposed image generation process in step S13, and when determining that the image mode selected by the user is the motion image mode (motion image mode in step S14), the processor 70 causes the display unit 10 to display the first image 210 and the first superimposed image 310 in sequence. After executing the second superimposed image generation process in step S13, and when determining that the image mode selected by the user is the motion image mode (motion image mode in step S14), the processor 70 causes the display unit 10 to display the first image 210 and the first superimposed image 410 in sequence.

When the processor 70 transitions to the motion image mode, the processor 70 first controls the display unit 10 to display the first image 210 on the projection surface 100 (step S18). Specifically, in step S18, the processor 70 reads the image data on the first image 210 as image data on N frames (N is integer greater than or equal to one) from the memory 60, and controls display unit 10 based on the read image data to display the first image 210 as the images of the N frames on the projection surface 100. That is, the processor 70 displays the first image 210 for the period of the N frames. The value of N is not limited to a specific value. For example, when the frame rate employed by the image display apparatus 1 is 60 frames per second, the value of N may be greater than or equal to 1 but smaller than or equal to 60.

After displaying the first image 210 for the period of the N frames, the processor 70 controls the display unit 10 to display the first superimposed image 310 or 410 on the projection surface 100 (step S19). Specifically, in step S19, the processor 70 reads the image data on the first superimposed image 310 or 410 as the image data on the N frames from the memory 60, and controls the display unit 10 based on the read image data to display the first superimposed image 310 or 410 as the images of the N frames on the projection surface 100. That is, the processor 70 displays the first superimposed image 310 or 410 for the period of the N frames.

After the first superimposed image 310 or 410 is displayed for the period of the N frames, the processor 70 determines based on the operation signal inputted from the operation section 30 or the remote operation signal inputted from the light receiver 40 whether the image mode has been changed by the user (step S20). When the processor 70 determines that the image mode has been changed by the user (Yes in step S20), the processor 70 returns to step S14.

On the other hand, when the processor 70 determines that the image mode has not been changed by the user (No in step S20), the processor 70 determines whether the user has pressed the termination operation key (step S21). When the processor 70 determines that the user has not pressed the termination operation key (No in step S21), the processor 70 returns to step S18 and keeps displaying the two images in sequence. On the other hand, when the processor 70 determines that the user has pressed the termination operation key (Yes in step S21), the processor 70 stops displaying the two images in sequence and then terminates the superimposed display mode.

As described above, in the motion image mode, unless the image mode is changed by the user, the first image 210 and the first superimposed image 310 (or 410) are repeatedly displayed on the projection surface 100 in sequence until the termination operation key is pressed by the user. As a result, the first athlete image P1, which shows the athlete P who is stationary in the crouch start posture, and the second athlete image P2, which shows the athlete P who starts charging out at full speed, are displayed in sequence, so that it appears to the user that the athlete P is moving. When the first superimposed image 310 (or 410) is displayed, the first athlete image P1 overlapping with the second athlete image P2 is visually recognized by the user as an afterimage. As described above, in the motion image mode, the two images displayed in sequence are visually recognized by the user as motion images showing the motion of the athlete P with the aid of the afterimage. When the image mode is changed by the user during the motion image mode, the image mode is switched to the still image mode described above.

### Effects of First Embodiment

As described above, the image generation method according to the first embodiment includes acquiring the first image 210, which is the image of a first frame, acquiring the second image 220, which is the image of a second frame following the first frame, and generating the first superimposed image 310 or 410, which is the result of superposition of the first image 210 and the second image 220.

The first embodiment described above allows generation of the first superimposed image 310 or 410 containing the first athlete image P1 contained in the first image 210, which is the oldest of the images of the two chronologically arranged frames, and the second athlete image P2 contained in the second image 220, which is the newest of the images of the two chronologically arranged frames. In other words, the first superimposed image 310 or 410 contains the first athlete image P1, which shows the athlete P at an earlier point of time during the period of the two chronologically arranged frames, and the second athlete image P2, which shows the athlete P at a point of time later than the first athlete image P1.

Since the first superimposed image 310 or 410 generated as described above is displayed as a single-screen image by the image display apparatus 1, the displayed first superimposed image 310 or 410 has a large size as compared with the size in the case where a plurality of still images are displayed side by side in chronological order on a single screen, as in the technology described in JP-A-2005-288014. The user can therefore visually capture small changes that appear in the form of the athlete P performing a predetermined action over the period of at least two frames by checking the two athlete images contained in the first superimposed image 310 or 410, which has a large display size.

In the image generation method according to the first embodiment, generating the first superimposed image 310 or 410 further includes generating the first transparent image by performing the transparency processing on the first image 210 based on the first transparency, generating the second transparent image by performing the transparency processing on the second image 220 based on the second transparency different from the first transparency, and superimposing the first transparent image and the second transparent image on each other.

According to the first embodiment described above, the first superimposed image 310 or 410 containing two athlete images different from each other in terms of shading is generated. The first superimposed image 310 or 410 displayed as described above allows the user to clearly distinguish the two athlete images contained in the first superimposed image 310 or 410 from each other. Therefore, for example, the user can more clearly capture small changes that appear in either the form of the athlete P who is stationary in the crouch start posture (that, first athlete image P1) or the form of the athlete P at the moment when the athlete P starts charging out at full speed (that is, second athlete image P2).

The image generation method according to the first embodiment further includes performing the transparency processing on the second image 220 based on the second transparency lower than the first transparency, and superimposing the second transparent image on the first transparent image.

The first embodiment described above allows generation of the first superimposed image 310 containing the first athlete image P1 having relatively light shading and the second athlete image P2 superimposed on the first athlete image P1 and having shading darker than that of the first athlete image P1. The first superimposed image 310 displayed as described above allows the user to visually recognize a temporally newer athlete image more clearly out of the two athlete images contained in the first superimposed image 310. Therefore, for example, the user can elaborately check the form of the athlete P particularly at the moment when the athlete P starts charging out at full speed (that is, second athlete image P2).

The image generation method according to the first embodiment further includes performing the transparency processing on the second image 220 based on the second transparency higher than the first transparency, and superimposing the first transparent image on the second transparent image.

The first embodiment described above allows generation of the first superimposed image 410 containing the second athlete image P2 having relatively light shading and the first athlete image P1 superimposed on the second athlete image P2 and having shading darker than that of the second athlete image P2. The first superimposed image 410 displayed as described above allows the user to visually recognize a temporally older athlete image more clearly out of the two athlete images contained in the first superimposed image 410. Therefore, for example, the user can elaborately check particularly the form of the athlete P who is stationary in the crouch start posture (that is, first athlete image P1).

The image display apparatus 1 according to the first embodiment includes the display unit 10, which displays an image, and the processor 70, which controls the display unit 10, and the processor 70 generates the first superimposed image 310 or 410 by executing the superimposed image generation process in the first embodiment (image generation method in first embodiment), and causes the display unit 10 to display the first superimposed image 310 or 410.

According to the first embodiment described above, the displayed first superimposed image 310 or 410 has a large size as compared with the size in the case where a plurality of still images are displayed side by side in chronological order on a single screen, as in the technology described in JP-A-2005-288014. The user can therefore visually capture small changes that appear in the form of the athlete P performing a predetermined action over the period of at least two frames by checking the two athlete images contained in the first superimposed image 310 or 410, which has a large display size. In particular, the image display apparatus 1, which is a projector, can display the first superimposed image 310 or 410 in a larger size than the size achieved by a non-projection-type image display apparatus, such as a liquid crystal monitor.

The image display apparatus 1 according to the first embodiment causes the display unit 10 to display the first superimposed image 310 or 410 as a still image.

According to the first embodiment described above, in which the first superimposed image 310 or 410 is displayed as a still image, the user can take time to check the first athlete image P1 and the second athlete image P2 contained in the first superimposed image 310 or 410, and can therefore more accurately evaluate the form of the athlete P.

The image display apparatus 1 according to the first embodiment causes the display unit 10 to display the first image 210 and the first superimposed image 310 (or 410) in sequence.

According to the first embodiment described above, the two images displayed in sequence are visually recognized by the user as motion images showing the motion of the athlete P with the aid of an afterimage. The user can thus check abnormalities in the form of the athlete P while watching a series of movements of the athlete P.

### Second Embodiment

A second embodiment will next be described. The second embodiment differs from the first embodiment in that the processor 70 executes different processes when the processor 70 transitions to the superimposed display mode. The following description will therefore relate to the processes executed by the processor 70 in the second embodiment when the processor 70 transitions to the superimposed display mode.

FIG. 10 is a flowchart showing processes executed by the processor 70 in the second embodiment when the processor 70 transitions to the superimposed display mode. The processor 70 reads the program from the memory 60 and executes the program to carry out each of the processes shown in the flowchart of FIG. 10. The method for controlling the image display apparatus 1 according to the second embodiment is realized by the processor 70 through execution of each of the processes shown in the flowchart of FIG. 10. In the description of the flowchart of FIG. 10, duplicated descriptions made in the flowchart of FIG. 3 will be simplified.

When the processor 70 transitions to the superimposed display mode, the processor 70 saves in the memory 60 the images of a plurality of most recent frames contained in the inputted video signal (step S51), as shown in FIG. 10. The second embodiment will be described with reference by way of example to a case where the processor 70 saves in the memory 60 the images of three most recent frames contained in the video signal.

Specifically, the processor 70 first sequentially saves in the memory 60 the images of the first, second, and third frames chronologically contained in the video signal. The processor 70 then sequentially saves in the memory 60 the images of the fourth, fifth, and sixth frames chronologically contained in the video signal. At this point, the images of the first, second, and third frames saved in the memory 60 are sequentially deleted. After the processor 70 repeats the processes described above, the memory 60 saves the images of the three most recent frames out of the frames chronologically contained in the video signal.

In step S51, the processor 70 controls the display unit 10 based on the video signal while saving in the memory 60 the three most recent frames contained in the video signal. Motion images based on the video signal are thus displayed on the projection surface 100. Assume that the motion images displayed on the projection surface 100 show the athlete P who participates a short-distance running race competes in the 100-meter race, as in the first embodiment.

After the processor 70 saves in the memory 60 the images of the three most recent frames contained in the video signal, the processor 70 determines whether the user has pressed the specific operation key based on the operation signal inputted from the operation section 30 or the remote operation signal inputted from the light receiver 40 (step S52). When the processor 70 determines that the user has not pressed the specific operation key (No in step S52), the processor 70 returns to step S51 and saves in the memory 60 the images of the next three most recent frames contained in the video signal.

On the other hand, when the processor 70 determines that the user has pressed the specific operation key (Yes in step S52), the processor 70 stops saving the images of the three most recent frames in the memory 60 and displaying the motion images based on the video signal, and then executes superimposed image generation process, which will be described later (step S53). In step S53, the processor 70 executes the superimposed image generation process of generating a superimposed image by superimposing the images of the three most recent frames saved in the memory 60. The image generation method according to the second embodiment is realized by the processor 70 through execution of the superimposed image generation process.

The superimposed image generation processes executed by the processor 70 will be described below with reference to two cases: a third superimposed image generation process; and a fourth superimposed image generation process. The processor 70 may execute one of the two superimposed image generation processes. Instead, the program may be so configured that the user can select one of the two superimposed image generation processes by operating the operation section 30 or the remote control. In this case, the processor 70 executes the superimposed image generation process selected by the user out of the two superimposed image generation processes based on the operation signal inputted from the operation section 30 or the remote operation signal inputted from the light receiver 40.

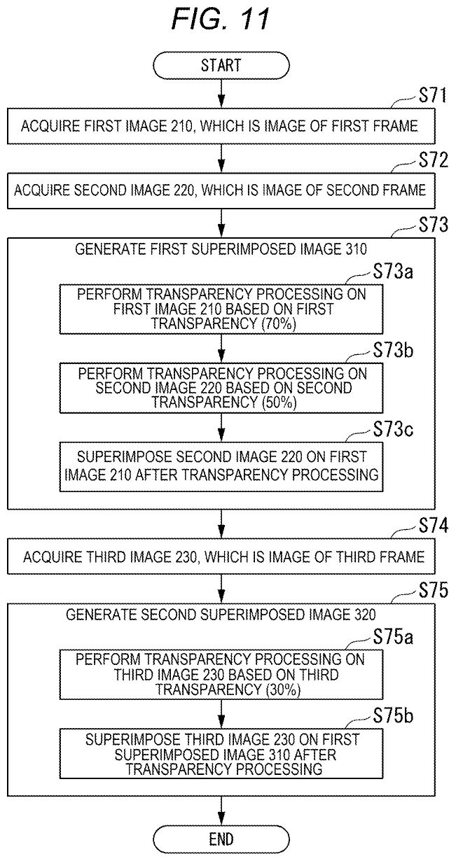

FIG. 11 is a flowchart showing the third superimposed image generation process executed by the processor 70. The processor 70 reads the program from the memory 60 and executes the program to execute the third superimposed image generation process shown in the flowchart of FIG. 11.

The processor 70 acquires the first image 210, which is the image of a first frame (step S71), as shown in FIG. 11. Specifically, in step S71, the processor 70 acquires the image of the oldest frame out of the images of the three most recent frames saved in the memory 60 as “the first image 210, which is the image of the first frame”. The first image 210 acquired in the second embodiment is the same as the first image 210 acquired in the first embodiment (see FIG. 5).

The processor 70 subsequently acquires the second image 220, which is the image of a second frame following the first frame (step S72). Specifically, in step S72, the processor 70 acquires the image of the second oldest frame out of the images of the three most recent frames saved in the memory 60 as “the second image 220, which is the image of the second frame”. The second image 220 acquired in the second embodiment is the same as the second image 220 acquired in the first embodiment (see FIG. 6).

The processor 70 subsequently generates the first superimposed image 310, which is a result of superposition of the first image 210 and the second image 220 (step S73). Step S73 includes three steps, step S73a, step S73b, and step S73c. When the processor 70 transitions to step S73, the processor 70 first generates the first transparent image by performing the transparency processing on the first image 210 based on the first transparency (step S73a). In the third superimposed image generation process, the first transparency is set in advance at a predetermined value. The first transparency is set at 70% by way of example. The first image 210 on which the transparency processing has been performed based on the first transparency corresponds to the first transparent image.

The processor 70 then generates the second transparent image by performing the transparency processing on the second image 220 based on the second transparency different from the first transparency (step S73b). Specifically, in step S73b, the processor 70 performs the transparency processing on the second image 220 based on the second transparency lower than the first transparency. In the third superimposed image generation process, the second transparency is set in advance at a predetermined value. The second transparency is set at 50% by way of example. The second image 220 on which the transparency processing has been performed based on the second transparency corresponds to the second transparent image.

After the transparency processing has been performed on the first image 210 and the second image 220, the processor 70 superimposes the first image 210 and the second image 220 on each other to generate the first superimposed image 310 (step S73c). That is, in step S73c, the processor 70 generates the first superimposed image 310 by superimposing the first transparent image and the second transparent image on each other. Specifically, after the transparency processing has been performed on the first image 210 and the second image 220, the processor 70 superimposes the second image 220 on the first image 210 in step S73c. That is, the processor 70 superimposes the second transparent image on the first transparent image. The first superimposed image 310 generated in the second embodiment is the same as the first superimposed image 310 generated in the first embodiment (see FIG. 7).

After executing the process in step S73 described above, the processor 70 acquires a third image 230, which is the image of a third frame following the second frame (step S74). Specifically, in step S74, the processor 70 acquires the image of the newest frame out of the images of the three most recent frames saved in the memory 60 as “the third image 230, which is the image of the third frame”.

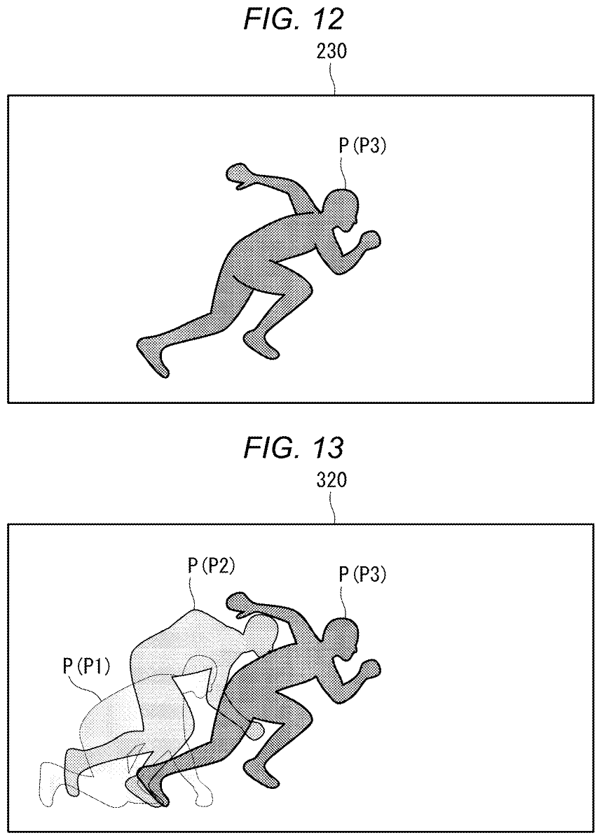

FIG. 12 shows an example of the third image 230 acquired by the processor 70. The third image 230 is an image showing the moment when the athlete P transitions from the charging-out posture to an accelerating posture, as shown in FIG. 12. In the following description, an image of the athlete P contained in the third image 230 is referred to as a “third athlete image P3” in some cases.

The processor 70 subsequently generates a second superimposed image 320, which is the result of superposition of the first superimposed image 310 and the third image 230 (step S75). Step S75 includes two steps, step S75a and step S75b. When the processor 70 transitions to step S75, the processor 70 first generates a third transparent image by performing the transparency processing on the third image 230 based on third transparency different from the first and second transparency (step S75a). Specifically, in step S75a, the processor 70 performs the transparency processing on the third image 230 based on the third transparency lower than the second transparency. In the third superimposed image generation process, the third transparency is set in advance at a predetermined value. The third transparency is set at 30% by way of example. The third image 230 on which the transparency processing has been performed based on the third transparency corresponds to the third transparent image.

After the transparency processing has been performed on the third image 230, the processor 70 superimposes the first superimposed image 310 and the third image 230 on each other to generate the second superimposed image 320 (step S75b). That is, in step S75b, the processor 70 generates the second superimposed image 320 by superimposing the first superimposed image 310 and the third transparent image on each other. Specifically, after the transparency processing has been performed on the third image 230, the processor 70 superimposes the third image 230 on the first superimposed image 310 in step S75b. That is, the processor 70 superimposes the third transparent image on the first superimposed image 310.

FIG. 13 shows an example of the second superimposed image 320 generated by the processor 70 through execution of the third superimposed image generation process. As described above, the processor 70 generates the second superimposed image 320 by superimposing the third image 230 on which the transparency processing has been performed at the third transparency of 30% lower than the first and second transparency on the first superimposed image 310. The operation described above generates the second superimposed image 320, which contains the first athlete image P1 having lightest shading, the second athlete image P2, which is superimposed on the first athlete image P1 and having shading darker than that of the first athlete image P1, and the third athlete image P3, which is superimposed on the second athlete image P2 and having shading darker than that of the second athlete image P2, as shown in FIG. 13.

The third superimposed image generation process executed by the processor 70 has been described. As clearly described above, the image generation method realized by the processor 70 through execution of the third superimposed image generation process includes acquiring the first image 210, which is the image of the first frame, (step S71), acquiring the second image 220, which is the image of the second frame following the first frame (step S72), generating the first superimposed image 310, which is the result of superimposition of the first image 210 and the second image 220 (step S73), acquiring the third image 230, which is the image of the third frame following the second frame (step S74), and generating the second superimposed image 320, which is the result of superposition of the first superimposed image 310 and the third image 230 (step S75).

Generating the first superimposed image 310 (step S73) further includes generating the first transparent image by performing the transparency processing on the first image 210 based on the first transparency (step S73a), generating the second transparent image by performing the transparency processing on the second image 220 based on the second transparency different from the first transparency (step S73b), and superimposing the first transparent image and the second transparent image on each other (step S73c). Generating the second superimposed image 320 (step S75) further includes generating the third transparent image by performing the transparency processing on the third image 230 based on the third transparency different from the first and second transparency (step S75a), and superimposing the first superimposed image 310 and the third transparent image on each other (step S75b).

More specifically, the image generation method according to the second embodiment further includes performing the transparency processing on the second image 220 based on the second transparency lower than the first transparency (step S73b), superimposing the second transparent image on the first transparent image (step S73c), performing the transparency processing on the third image 230 based on the third transparency lower than the second transparency (step S75a), and superimposing the third transparent image on the first superimposed image 310 (step S75b).

The fourth superimposed image generation process executed by the processor 70 will be described below.

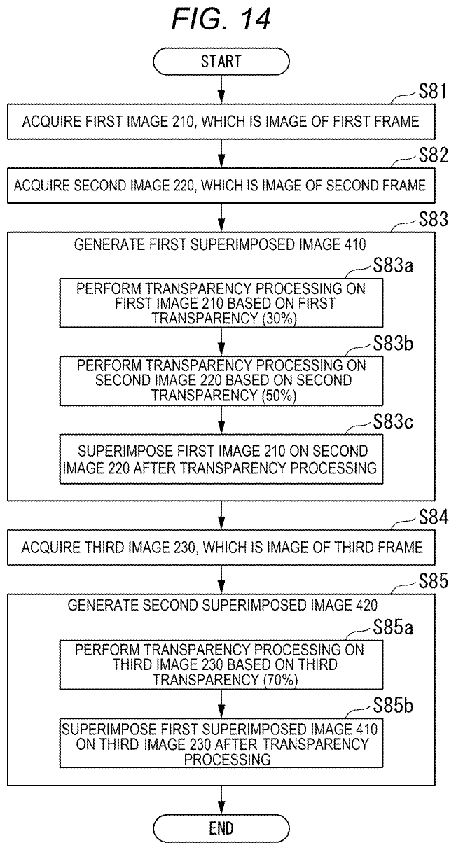

FIG. 14 is a flowchart showing the fourth superimposed image generation process executed by the processor 70. The processor 70 reads the program from the memory 60 and executes the program to execute the fourth superimposed image generation process shown in the flowchart of FIG. 14. Among the steps contained in the fourth superimposed image generation process, the same steps as those in the third superimposed image generation process will be described in a simplified manner.

The processor 70 acquires the first image 210, which is the image of a first frame (step S81), as shown in FIG. 14. The processor 70 subsequently acquires the second image 220, which is the image of a second frame following the first frame (step S82).

The processor 70 subsequently generates the first superimposed image 410, which is the result of superposition of the first image 210 and the second image 220 (step S83). Step S83 includes three steps, step S83a, step S83b, and step S83c. When the processor 70 transitions to step S83, the processor 70 first generates the first transparent image by performing the transparency processing on the first image 210 based on the first transparency (step S83a). In the fourth superimposed image generation process, the first transparency is set in advance at a predetermined value. The first transparency is set at 30% by way of example.

The processor 70 then generates the second transparent image by performing the transparency processing on the second image 220 based on the second transparency different from first transparency (step S83b). Specifically, in step S83b, the processor 70 performs the transparency processing on the second image 220 based on the second transparency higher than the first transparency. In the fourth superimposed image generation process, the second transparency is set in advance at a predetermined value. The second transparency is set at 50% by way of example.

After the transparency processing has been performed on the first image 210 and the second image 220, the processor 70 superimposes the first image 210 and the second image 220 on each other to generate the first superimposed image 410 (step S83c). That is, in step S83c, the processor 70 generates the first superimposed image 410 by superimposing the first transparent image and the second transparent image on each other. Specifically, after the transparency processing has been performed on the first image 210 and the second image 220, the processor 70 superimposes the first image 210 on the second image 220 in step S83c. That is, the processor 70 superimposes the first transparent image on the second transparent image. The first superimposed image 410 generated in the second embodiment is the same as the first superimposed image 410 generated in the first embodiment (see FIG. 9).

After executing the process in step S83 described above, the processor 70 acquires the third image 230, which is the image of a third frame following the second frame (step S84). The processor 70 subsequently generates a second superimposed image 420, which is the result of superposition of the first superimposed image 410 and the third image 230 (step S85). Step S85 includes two steps, step S85a and step S85b.

When the processor 70 transitions to step S85, the processor 70 first generates the third transparent image by performing the transparency processing on the third image 230 based on the third transparency different from the first and second transparency (step S85a). Specifically, in step S85a, the processor 70 performs the transparency processing on the second image 230 based on the third transparency higher than the second transparency. In the fourth superimposed image generation process, the third transparency is set in advance at a predetermined value. The third transparency is set at 70% by way of example.

After the transparency processing has been performed on the third image 230, the processor 70 superimposes the first superimposed image 410 and the third image 230 on each other to generate the second superimposed image 420 (step S85b). That is, in step S85b, the processor 70 generates the second superimposed image 420 by superimposing the first superimposed image 410 and the third transparent image on each other. Specifically, after the transparency processing has been performed on the third image 230, the processor 70 superimposes the first superimposed image 410 on the third image 230 in step S85b. That is, the processor 70 superimposes the first superimposed image 410 on the third transparent image.

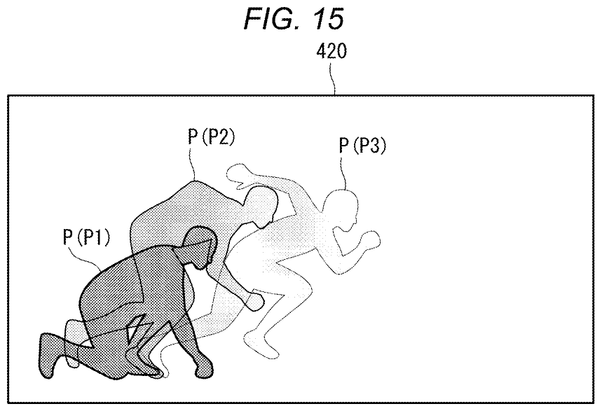

FIG. 15 shows an example of the second superimposed image 420 generated by the processor 70 through execution of the fourth superimposed image generation process. As described above, the processor 70 generates the second superimposed image 420 by superimposing the first superimposed image 410 on the third image 230 on which the transparency processing has been performed at the third transparency of 70% higher than the first and second transparency. The operation described above generates the second superimposed image 420 containing the third athlete image P3 having lightest shading, the second athlete image P2 superimposed on the third athlete image P3 and having shading darker than that of the third athlete image P3, and the first athlete image P1 superimposed on the second athlete image P2 and having shading darker than that of the second athlete image P2, as shown in FIG. 15.

The fourth superimposed image generation process executed by the processor 70 has been described. As clearly described above, the image generation method realized by the processor 70 through execution of the fourth superimposed image generation process includes acquiring the first image 210, which is the image of the first frame, (step S81), acquiring the second image 220, which is the image of the second frame following the first frame (step S82), generating the first superimposed image 410, which is the result of superimposition of the first image 210 and the second image 220 (step S83), acquiring the third image 230, which is the image of the third frame following the second frame (step S84), and generating the second superimposed image 420, which is the result of superposition of the first superimposed image 410 and the third image 230 (step S85).

Generating the first superimposed image 410 (step S83) further includes generating the first transparent image by performing the transparency processing on the first image 210 based on the first transparency (step S83a), generating the second transparent image by performing the transparency processing on the second image 220 based on the second transparency different from the first transparency (step S83b), and superimposing the first transparent image and the second transparent image on each other (step S83c). Generating the second superimposed image 420 (step S85) further includes generating the third transparent image by performing the transparency processing on the third image 230 based on the third transparency different from the first and second transparency (step S85a), and superimposing the first superimposed image 410 and the third transparent image on each other (step S85b).

More specifically, the image generation method according to the second embodiment further includes performing the transparency processing on the second image 220 based on the second transparency higher than the first transparency (step S83b), superimposing the first transparent image on the second transparent image (step S83c), performing the transparency processing on the third image 230 based on the third transparency higher than the second transparency (step S85a), and superimposing the first superimposed image 410 on the third transparent image (step S85b).

The description will resume with reference back to the flowchart of FIG. 10. When the processor 70 terminates the third or fourth superimposed image generation process described above, the processor 70 transitions to step S54 in the flowchart of FIG. 10. When the processor 70 transitions to step S54, the processor 70 determines whether the image mode selected by the user is the still image mode or the motion image mode based on the operation signal inputted from the operation section 30 or the remote operation signal inputted from the light receiver 40 (step S54).

The action of the processor 70 in the still image mode will first be described.

When the processor 70 determines that the image mode selected by the user is the still image mode (still image mode in step S54), the processor 70 controls the display unit 10 to display the second superimposed image 320 generated by the third superimposed image generation process, or the second superimposed image 420 generated by the fourth superimposed image generation process on the projection surface 100 as a still image (step S55).

Specifically, in step S55, the processor 70 reads the image data on the second superimposed image 320 or 420 as image data on each frame from the memory 60, and controls the display unit 10 based on the read image data to display the second superimposed image 320 or 420 as the image data on each frame on the projection surface 100.

When the period for which the second superimposed image 320 or 420 has been displayed reaches a predetermined period, the processor 70 determines based on the operation signal inputted from the operation section 30 or the remote operation signal inputted from the light receiver 40 whether the image mode has been changed by the user (step S56). When the processor 70 determines that the image mode has been changed by the user (Yes in step S56), the processor 70 stops displaying the second superimposed image 320 or 420 as a still image and returns to step S54.

On the other hand, when the processor 70 determines that the image mode has not been changed by the user (No in step S56), the processor 70 determines whether the user has pressed the termination operation key (step S57). When the processor 70 determines that the user has not pressed the termination operation key (No in step S57), the processor 70 returns to step S55 and keeps displaying the second superimposed image 320 or 420 as a still image.

When the period for which the second superimposed image 320 or 420 has been displayed reaches the predetermined time again from the time when the processor 70 has returned to step S55, the processor 70 executes step S56. On the other hand, when the processor 70 determines that the user has pressed the termination operation key (Yes in step S57), the processor 70 stops displaying the second superimposed image 320 or 420 as a still image and terminates the superimposed display mode.

As described above, in the still image mode, unless the image mode is changed by the user, the second superimposed image 320 or 420 keeps being displayed as a still image on the projection surface 100 until the user presses the termination operation key. When the image mode is changed by the user during the still image mode, the image mode is switched to the motion image mode, which will be described later.

The action of the processor 70 in the motion image mode will next be described.

After executing the third superimposed image generation process in step S53, and when determining that the image mode selected by the user is the motion image mode (motion image mode in step S54), the processor 70 causes the display unit 10 to display the first image 210, the first superimposed image 310, and the second superimposed image 320 in sequence. After executing the fourth superimposed image generation process in step S53, and when determining that the image mode selected by the user is the motion image mode (motion image mode in step S54), the processor 70 causes the display unit 10 to display the first image 210, the first superimposed image 410, and the second superimposed image 420 in sequence.

Specifically, when the processor 70 transitions to the motion image mode, the processor 70 first controls the display unit 10 to display the first image 210 on the projection surface 100 (step S58). Specifically, in step S58, the processor 70 reads the image data on the first image 210 as image data on N frames from the memory 60, and controls the display unit 10 based on the read image data to display the first image 210 as the images of the N frames on the projection surface 100. That is, the processor 70 displays the first image 210 for the period of the N frames.

After displaying the first image 210 for the period of the N frames, the processor 70 controls the display unit 10 to display the first superimposed image 310 or 410 on the projection surface 100 (step S59). Specifically, in step S59, the processor 70 reads the image data on the first superimposed image 310 or 410 as the image data on the N frames from the memory 60, and controls the display unit 10 based on the read image data to display the first superimposed image 310 or 410 as the images of the N frames on the projection surface 100. That is, the processor 70 displays the first superimposed image 310 or 410 for the period of the N frames.

After displaying the first superimposed image 310 or 410 for the period of the N frames, the processor 70 controls the display unit 10 to display the second superimposed image 320 or 420 on the projection surface 100 (step S60). Specifically, in step S60, the processor 70 reads the image data on the second superimposed image 320 or 420 as the image data on the N frames from the memory 60, and controls display unit 10 based on the read image data to display the second superimposed image 320 or 420 as the images of the N frames on the projection surface 100. That is, the processor 70 displays the second superimposed image 320 or 420 for the period of the N frames.

After the second superimposed image 320 or 420 is displayed for the period of the N frames, the processor 70 determines whether the image mode has been changed by the user based on the operation signal inputted from the operation section 30 or the remote operation signal inputted from the light receiver 40 (step S61). When the processor 70 determines that the image mode has been changed by the user (Yes in step S61), the processor 70 returns to step S54.

On the other hand, when the processor 70 determines that the image mode has not been changed by the user (No in step S61), the processor 70 determines whether the user has pressed the termination operation key (step S62). When the processor 70 determines that the user has not pressed the termination operation key (No in step S62), the processor 70 returns to step S58 and keeps displaying the three images in sequence. On the other hand, when the processor 70 determines that the user has pressed the termination operation key (Yes in step S62), the processor 70 stops displaying the three images in sequence and terminates the superimposed display mode.

As described above, in the motion image mode, unless the image mode is changed by the user, the first image 210, the first superimposed image 310 (or 410), and the second superimposed image 320 (or 420) are repeatedly displayed on the projection surface 100 in sequence until the user presses the termination operation key. As a result, the first athlete image P1, which shows the athlete P who is stationary in the crouch start posture, the second athlete image P2, which shows the athlete P who starts charging out at full speed, and the third athlete image P3, which shows the athlete P who transitions to the accelerating posture are displayed in sequence, so that it appears to the user that the athlete P is moving. When the second superimposed image 320 (or 420) is displayed, the first athlete image P1 and the second athlete image P2 overlapping with the third athlete image P3 are visually recognized by the user as an afterimage. As described above, in the motion image mode, the three images displayed in sequence are visually recognized by the user as motion images showing the motion of the athlete P with the aid of the afterimage. When the image mode is changed by the user during the motion image mode, the image mode is switched to the still image mode described above.

### Effects of Second Embodiment

As described above, the image generation method according to the second embodiment includes acquiring the first image 210, which is the image of the first frame, acquiring the second image 220, which is the image of the second frame following the first frame, generating the first superimposed image 310 or 410, which is the result of superimposition of the first image 210 and the second image 220, acquiring the third image 230, which is the image of the third frame following the second frame, and generating the second superimposed image 320 or 420, which is the result of superposition of the first superimposed image 310 or 410 and the third image 230.

The second embodiment described above allows generation of the second superimposed image 320 or 420 containing the first athlete image P1 contained in the first image 210, which is the oldest of the images of the three chronologically arranged frames, the second athlete image P2 contained in the second image 220, which is the second oldest of the three images, and the third athlete image P3 contained in the third image 230, which is the newest of the three images. In other words, the second superimposed image 320 or 420 contains the first athlete image P1 showing the athlete P having the oldest posture during the period of the three chronologically arranged frames, the second athlete image P2 showing the athlete P having a posture newer than that in the first athlete image P1, and the third athlete image P3 showing the athlete P having a posture newer than that in the second athlete image P2.

Since the second superimposed image 320 or 420 generated as described above is displayed as a single-screen image by the image display apparatus 1, the displayed second superimposed image 320 or 420 has a large size as compared with the size in the case where a plurality of still images are displayed side by side in chronological order on a single screen, as in the technology described in JP-A-2005-288014. The user can therefore visually capture small changes that appear in the form of the athlete P performing a predetermined action over the period of three frames, which is longer than the period in the first embodiment, by checking three athlete images contained in the second superimposed image 320 or 420, which has a large display size.

In the image generation method according to the second embodiment, generating the first superimposed image 310 or 410 further includes generating the first transparent image by performing the transparency processing on the first image 210 based on the first transparency, generating the second transparent image by performing the transparency processing on the second image 220 based on the second transparency different from the first transparency, and superimposing the first transparent image and the second transparent image on each other, and generating the second superimposed image 320 or 420 further includes generating the third transparent image by performing the transparency processing on the third image 230 based on the third transparency different from the first and second transparency, and superimposing the first superimposed image 310 or 410 and the third transparent image on each other.

According to the second embodiment described above, the second superimposed image 320 or 420 containing three athlete images different from one another in terms of shading is generated. The second superimposed image 320 or 420 displayed as described above allows the user to clearly distinguish the three athlete images contained in the second superimposed image 320 or 420 from each other. Therefore, for example, the user can more clearly capture small changes that appear in any of the form of the athlete P who is stationary in the crouch start posture (that, first athlete image P1), the form of the athlete P at the moment when the athlete P starts charging out at full speed (that is, second athlete image P2), and the form of the athlete P at the moment when the athlete P transitions to the accelerating posture (that is, third athlete image P3).

The image generation method according to the second embodiment further includes performing the transparency processing on the second image 220 based on the second transparency lower than the first transparency, superimposing the second transparent image on the first transparent image, performing the transparency processing on the third image 230 based on the third transparency lower than the second transparency, and superimposing the third transparent image on the first superimposed image 310.

The second embodiment described above allows generation of the second superimposed image 320 containing the first athlete image P1 having lightest shading, the second athlete image P2 superimposed on the first athlete image P1 and having shading darker than that of the first athlete image P1, and the third athlete image P3 superimposed on the second athlete image P2 and having shading darker than that of the second athlete image P2. The second superimposed image 320 displayed as described above allows the user to visually recognize a temporally newer athlete image more clearly out of the three athlete images contained in the second superimposed image 320. Therefore, for example, the user can elaborately check the form of the athlete P particularly at the moment when the athlete P transitions to the accelerating posture (that is, third athlete image P3).

The image generation method according to the second embodiment further includes performing the transparency processing on the second image 220 based on the second transparency higher than the first transparency, superimposing the first transparent image on the second transparent image, performing the transparency processing on the third image 230 based on the third transparency higher than the second transparency, and superimposing the first superimposed image 410 on the third transparent image.

The second embodiment described above allows generation of the second superimposed image 420 containing the third athlete image P3 having relatively light shading, the second athlete image P2 superimposed on the third athlete image P3 and having shading darker than that of the third athlete image P3, and the first athlete image P1 superimposed on the second athlete image P2 and having shading darker than that of the second athlete image P2. The second superimposed image 420 displayed as described above allows the user to visually recognize a temporally older athlete image more clearly out of the three athlete images contained in the second superimposed image 420. Therefore, for example, the user can elaborately check particularly the form of the athlete P who is stationary in the crouch start posture (that is, first athlete image P1).

The image display apparatus 1 according to the second embodiment includes the display unit 10, which displays an image, and the processor 70, which controls the display unit 10, and the processor 70 generates the second superimposed image 320 or 420 by executing the superimposed image generation process in the second embodiment (image generation method in second embodiment), and causes the display unit 10 to display the second superimposed image 320 or 420.

According to the second embodiment described above, the displayed second superimposed image 320 or 420 has a large size as compared with the size in the case where a plurality of still images are displayed side by side in chronological order on a single screen, as in the technology described in JP-A-2005-288014. The user can therefore visually capture small changes that appear in the form of the athlete P performing a predetermined action over the period of three frames, which is longer than the period in the first embodiment, by checking three athlete images contained in the second superimposed image 320 or 420, which has a large display size. In particular, the image display apparatus 1, which is a projector, can display the first superimposed image 310 or 410 in a larger size than the size achieved by a non-projection-type image display apparatus, such as a liquid crystal monitor.

The image display apparatus 1 according to the second embodiment causes the display unit 10 to display the second superimposed image 320 or 420 as a still image.

According to the second embodiment described above, in which the second superimposed image 320 or 410 is displayed as a still image, the user can take time to check the three athlete images contained in the second superimposed image 320 or 420, and can therefore more accurately evaluate the form of the athlete P.

The image display apparatus 1 according to the second embodiment causes the display unit 10 to display the first image 210, the first superimposed image 310 (or 410), and the second superimposed image 320 (or 420) in sequence.

According to the second embodiment described above, the three images displayed in sequence are visually recognized by the user as motion images showing the motion of the athlete P with the aid of an afterimage. The user can thus check abnormalities in the form of the athlete P while watching a series of movements of the athlete P.

The first and second embodiments of the present disclosure have been described above, but the technical range of the present disclosure is not limited to the embodiments described above, and a variety of changes can be made thereto to the extent that the changes do not depart from the intent of the present disclosure.

(1) In the first embodiment, when the processor 70 performs the transparency processing on the second image 220 based on the second transparency lower than the first transparency, the first transparency is set in advance at 70%, and the second transparency is set in advance at 50%. The processor 70 may instead, before generating the first superimposed image 310 (step S33 in FIG. 4), calculate a first difference that is the difference between the first image 210 and the second image 220, set the second transparency at a value smaller than the first transparency when the first difference is greater than or equal to a first predetermined value, and superimpose the second transparent image on the first transparent image.

In other words, the image generation method in the first embodiment may further include, before generating the first superimposed image 310, calculating the first difference, which is the difference between the first image 210 and the second image 220, setting the second transparency at a value smaller than the first transparency when the first difference is greater than or equal to the first predetermined value, and superimposing the second transparent image on the first transparent image. As an example, the first difference between the first image 210 and the second image 220 is the total number of pixels different from those of the first image 210 in terms of luminance out of the pixels contained in the second image 220. The first predetermined value is a value determined in advance based on the result of an experiment, a simulation, or the like.

According to the variation described above, when the motion of the athlete P drastically changes for the period of two frames, the first superimposed image 310, which contains the first athlete image P1 having relatively light shading and the second athlete image P2 having shading darker than that of the first athlete image P1, is generated. Therefore, when the motion of the athlete P drastically changes, that is, when the user needs to elaborately check the form of the athlete P, the user can visually recognize more clearly a temporally newer athlete image out of the two athlete images contained in the first superimposed image 310.

(2) In the first embodiment, when the processor 70 performs the transparency processing on the second image 220 based on the second transparency greater than the first transparency, the first transparency is set in advance at 30%, and the second transparency is set in advance at 50%. The processor 70 may instead, before generating the first superimposed image 410 (step S43 in FIG. 8), calculate the first difference, which is the difference between the first image 210 and the second image 220, set the second transparency at a value greater than the first transparency when the first difference is greater than or equal to the first predetermined value, and superimpose the first transparent image on the second transparent image.

In other words, the image generation method in the first embodiment may further include, before generating the first superimposed image 410, calculating the first difference, which is the difference between the first image 210 and the second image 220, setting the second transparency at a value greater than the first transparency when the first difference is greater than or equal to the first predetermined value, and superimposing the first transparent image on the second transparent image.

According to the variation described above, when the motion of the athlete P drastically changes for the period of two frames, the first superimposed image 410, which contains the first athlete image P1 having relatively dark shading and the second athlete image P2 having shading lighter than that of the first athlete image P1, is generated. Therefore, when the motion of the athlete P drastically changes, that is, when the user needs to elaborately check the form of the athlete P, the user can visually recognize more clearly a temporally older athlete image out of the two athlete images contained in the first superimposed image 410.

(3) In the second embodiment, when the processor 70 performs the transparency processing on the second image 220 based on the second transparency lower than the first transparency, the first transparency is set in advance at 70%, and the second transparency is set in advance at 50%. Furthermore, in the second embodiment, when the processor 70 performs the transparency processing on the third image 230 based on the third transparency lower than the second transparency, the third transparency is set in advance at 30%.

The processor 70 may instead, before generating the first superimposed image 310 (step S73 in FIG. 11), calculate the first difference, which is the difference between the first image 210 and the second image 220, set the second transparency at a value smaller than the first transparency when the first difference is greater than or equal to the first predetermined value, and superimpose the second transparent image on the first transparent image. Furthermore, the processor 70 may, before generating the second superimposed image 320 (step S75 in FIG. 11), calculate a second difference that is the difference between the second image 220 and the third image 230, set the third transparency at a value smaller than the second transparency when the second difference is greater than or equal to a second predetermined value, and superimpose the third transparent image on the first superimposed image 310.

In other words, the image generation method in the second embodiment may further include, before generating the first superimposed image 310, calculating the first difference, which is the difference between the first image 210 and the second image 220, setting the second transparency at a value smaller than the first transparency when the first difference is greater than or equal to the first predetermined value, and superimposing the second transparent image on the first transparent image. Furthermore, the image generation method in the second embodiment may further include, before generating the second superimposed image 320, calculating the second difference, which is the difference between the second image 220 and the third image 230, setting the third transparency at a value smaller than the second transparency when the second difference is greater than or equal to the second predetermined value, and superimposing the third transparent image on the first superimposed image 310.

As an example, the second difference between the second image 220 and the third image 230 is the total number of pixels different from those of the second image 220 in terms of luminance out of the pixels contained in the third image 230. The second predetermined value is a value determined in advance based on the result of an experiment, a simulation, or the like. The second predetermined value may be equal to or different from the first predetermined value.

According to the variation described above, when the motion of the athlete P drastically changes for the period of three frames, the second superimposed image 320, which contains the first athlete image P1 having the lightest shading, the second athlete image P2 having shading darker than that of the first athlete image P1, and the third athlete image P3 having shading darker than that of the second athlete image P2, is generated. Therefore, when the motion of the athlete P drastically changes, that is, when the user needs to elaborately check the form of the athlete P, the user can visually recognize more clearly a temporally newer athlete image out of the three athlete images contained in the second superimposed image 320.

(4) In the second embodiment, when the processor 70 performs the transparency processing on the second image 220 based on the second transparency higher than the first transparency, the first transparency is set in advance at 30%, and the second transparency is set in advance at 50%. Furthermore, in the second embodiment, when the processor 70 performs the transparency processing on the third image 230 based on the third transparency higher than the second transparency, the third transparency is set in advance at 70%.

The processor 70 may instead, before generating the first superimposed image 410 (step S83 in FIG. 14), calculate the first difference, which is the difference between the first image 210 and the second image 220, set the second transparency at a value greater than the first transparency when the first difference is greater than or equal to the first predetermined value, and superimpose the first transparent image on the second transparent image. Furthermore, the processor 70 may, before generating the second superimposed image 420 (step S85 in FIG. 14), calculate the second difference, which is the difference between the second image 220 and the third image 230, set the third transparency at a value greater than the second transparency when the second difference is greater than or equal to the second predetermined value, and superimpose the first superimposed image 410 on the third transparent image.

In other words, the image generation method in the second embodiment may further, before generating the first superimposed image 410, include calculating the first difference, which is the difference between the first image 210 and the second image 220, setting the second transparency at a value smaller than the first transparency when the first difference is greater than or equal to the first predetermined value, and superimposing the first transparent image on the second transparent image. Furthermore, the image generation method in the second embodiment may further include, before generating the second superimposed image 420, calculating the second difference, which is the difference between the second image 220 and the third image 230, setting the third transparency at a value greater than the second transparency when the second difference is greater than or equal to the second predetermined value, and superimposing the first superimposed image 410 on the third transparent image.

According to the variation described above, when the motion of the athlete P drastically changes for the period of three frames, the second superimposed image 420, which contains the first athlete image P1 having the darkest shading, the second athlete image P2 having shading lighter than that of the first athlete image P1, and the third athlete image P3 having shading lighter than that of the second athlete image P2, is generated. Therefore, when the motion of the athlete P drastically changes, that is, when the user needs to elaborately check the form of the athlete P, the user can visually recognize more clearly a temporally older athlete image out of the three athlete images contained in the second superimposed image 420.

(5) The first embodiment has been described with reference to the form in which the first superimposed image 310 or 410 is generated by superimposing the images of two most recent frames. The second embodiment has been described with reference to the form in which the first superimposed image 310 or 410 is generated by superimposing the images of the first and second frames out of three most recent frames and then the second superimposed image 320 or 420 is generated by superimposing the image of the third frame and the first superimposed image 310 or 410 on each other.

For example, when the images of four most recent frames are used, the processor 70 may further acquire the image of the fourth frame, which is the newest of the four most recent frames, as the fourth image and generate a third superimposed image by superimposing the fourth image and the second superimposed image 320 or 420 on each other.

In this case, before generating the third superimposed image, the processor 70 may generate the fourth transparent image by performing the transparency processing on the fourth image based on fourth transparency lower or higher than the third transparency. When performing the transparency processing on the fourth image based on the fourth transparency lower than the third transparency, the processor 70 superimposes the fourth transparent image on the second superimposed image 320. On the other hand, when performing the transparency processing on the fourth image based on the fourth transparency higher than the third transparency, the processor 70 superimposes the second superimposed image 420 on the fourth transparent image.

Similarly, when the images of five or more most recent frames are used, necessary processing may be added in accordance with the same approach described above. Instead, the program may be so configured that the user can select a desired number of frames by operating the operation section 30 or the remote control. In this case, the program may be so configured that the processor 70 sets each transparency in accordance with the number of frames selected by the user. For example, when the number of frames selected by the user is four, that is, when the images of four most recent frames are used, the processor 70 may set each transparency in such a way that the transparency varies by an increment of 25%, which is the quotient of division of 100% by 4. In this case, the processor 70 may set the first transparency at 100%, the second transparency at 75%, the third transparency at 50%, and the fourth transparency at 25%. The processor 70 may instead set the first transparency at 25%, the second transparency at 50%, the third transparency at 75%, and the fourth transparency at 100%.

(6) The aforementioned embodiments have been described with reference to the case where the moving object under evaluation is the athlete P who participates a short-distance running race and the image display apparatus 1 is used to check the form of the athlete P, but the moving subject under evaluation is not limited to the athlete P who participates a short-distance running race. For example, the image display apparatus 1 may instead be used to check the form of an athlete in any other track and field event, such as running hurdles and the high jump, or an athlete in any other sport, such as golf and tennis. The image display apparatus 1 may still instead be used to check the form of an ordinary person who is not a competitive athlete but plays a variety of sports as a hobby.

(7) The aforementioned embodiments have been described with reference to the case where the image display apparatus 1 is a projector, but the image display apparatus according to the present disclosure is not limited to a projector. For example, the image display apparatus according to the present disclosure may be any other electronic instrument having an image display function, such as a personal computer and a smartphone. In general, an electronic instrument, such as a personal computer and a smartphone, includes a display as a display unit and a processor that controls the display, and it can therefore be said that any of the electronic instruments described above is a form of the image display apparatus.

An image generation method according to an aspect of the present disclosure may have the configuration below.

The image generation method according to the aspect of the present disclosure includes acquiring a first image that is the image of a first frame, acquiring a second image that is the image of a second frame following the first frame, and generating a first superimposed image that is the result of superposition of the first image and the second image.

In the image generation method according to the aspect of the present disclosure, generating the first superimposed image may further include generating a first transparent image by performing transparency processing on the first image based on first transparency, generating a second transparent image by performing the transparency processing on the second image based on second transparency different from the first transparency, and superimposing the first transparent image and the second transparent image on each other.

The image generation method according to the aspect of the present disclosure may further include performing the transparency processing on the second image based on the second transparency lower than the first transparency, and superimposing the second transparent image on the first transparent image.

The image generation method according to the aspect of the present disclosure may further include, before generating the first superimposed image, calculating a first difference that is the difference between the first image and the second image, setting the second transparency at a value smaller than the first transparency when the first difference is greater than or equal to a first predetermined value, and superimposing the second transparent image on the first transparent image.

The image generation method according to the aspect of the present disclosure may further include performing the transparency processing on the second image based on the second transparency higher than the first transparency, and superimposing the first transparent image on the second transparent image.

The image generation method according to the aspect of the present disclosure may further include, before generating the first superimposed image, calculating a first difference that is the difference between the first image and the second image, setting the second transparency at a value greater than the first transparency when the first difference is greater than or equal to a first predetermined value, and superimposing the first transparent image on the second transparent image.

The image generation method according to the aspect of the present disclosure may further include acquiring a third image that is the image of a third frame following the second frame, and generating a second superimposed image that is the result of superposition of the first superimposed image and the third image.

In the image generation method according to the aspect of the present disclosure, generating the first superimposed image may further include generating a first transparent image by performing transparency processing on the first image based on first transparency, generating a second transparent image by performing the transparency processing on the second image based on second transparency different from the first transparency, and superimposing the first transparent image and the second transparent image on each other, and generating the second superimposed image may further include generating a third transparent image by performing the transparency processing on the third image based on third transparency different from the first and second transparency, and superimposing the first superimposed image and the third transparent image on each other.

The image generation method according to the aspect of the present disclosure may further include performing the transparency processing on the second image based on the second transparency lower than the first transparency, superimposing the second transparent image on the first transparent image, performing the transparency processing on the third image based on the third transparency lower than the second transparency, and superimposing the third transparent image on the first superimposed image.

The image generation method according to the aspect of the present disclosure may further include, before generating the first superimposed image, calculating a first difference that is the difference between the first image and the second image, setting the second transparency at a value smaller than the first transparency when the first difference is greater than or equal to a first predetermined value, and superimposing the second transparent image on the first transparent image, and may still further include, before generating the second superimposed image, calculating a second difference that is the difference between the second image and the third image, setting the third transparency at a value smaller than the second transparency when the second difference is greater than or equal to a second predetermined value, and superimposing the third transparent image on the first superimposed image.

The image generation method according to the aspect of the present disclosure may further include performing the transparency processing on the second image based on the second transparency higher than the first transparency, superimposing the first transparent image on the second transparent image, performing the transparency processing on the third image based on the third transparency higher than the second transparency, and superimposing the first superimposed image on the third transparent image.

The image generation method according to the aspect of the present disclosure may further include, before generating the first superimposed image, calculating a first difference that is the difference between the first image and the second image, setting the second transparency at a value greater than the first transparency when the first difference is greater than or equal to a first predetermined value, and superimposing the first transparent image on the second transparent image, and may further include, before generating the second superimposed image, calculating a second difference that is the difference between the second image and the third image, setting the third transparency at a value greater than the second transparency when the second difference is greater than or equal to a second predetermined value, and superimposing the first superimposed image on the third transparent image.

An image display apparatus according to an aspect of the present disclosure may have the configuration below.

The image display apparatus according to the aspect of the present disclosure includes a display apparatus that displays an image, and a processor that controls the display apparatus, and the processor generates the first superimposed image described above by executing the image generation method according to the aspect described above, and causes the display unit to display the first superimposed image.

The image display apparatus according to the aspect of the present disclosure may cause the display unit to display the first superimposed image as a still image.

The image display apparatus according to the aspect of the present disclosure may cause the display unit to display the first image described above and the first superimposed image in sequence.

An image display apparatus according to an aspect of the present disclosure may have the configuration below.

The image display apparatus according to the aspect of the present disclosure includes a display unit that displays an image, and a processor that controls the display unit, and the processor generates the second superimposed image described above by executing the image generation method according to the aspect described above, and causes the display unit to display the second superimposed image.

The image display apparatus according to the aspect of the present disclosure may cause the display unit to display the second superimposed image as a still image.

The image display apparatus according to the aspect of the present disclosure may cause the display unit to display the first image described above, the first superimposed image described above, and the second superimposed image in sequence.

What is claimed is:

1. An image generation method comprising:
acquiring a first image that is an image of a first frame;
acquiring a second image that is an image of a second frame following the first frame; and
generating a first superimposed image that is a result of superposition of the first image and the second image.

2. The image generation method according to claim 1,
wherein generating the first superimposed image further includes
generating a first transparent image by performing transparency processing on the first image based on first transparency,
generating a second transparent image by performing the transparency processing on the second image based on second transparency different from the first transparency, and
superimposing the first transparent image and the second transparent image on each other.

3. The image generation method according to claim 2, further comprising:
performing the transparency processing on the second image based on the second transparency lower than the first transparency, and
superimposing the second transparent image on the first transparent image.

4. The image generation method according to claim 2, further comprising:
before generating the first superimposed image,
calculating a first difference that is a difference between the first image and the second image,
setting the second transparency at a value smaller than the first transparency when the first difference is greater than or equal to a first predetermined value, and
superimposing the second transparent image on the first transparent image.

5. The image generation method according to claim 2, further comprising:
performing the transparency processing on the second image based on the second transparency higher than the first transparency, and
superimposing the first transparent image on the second transparent image.

6. The image generation method according to claim 2, further comprising:
before generating the first superimposed image,
calculating a first difference that is a difference between the first image and the second image,
setting the second transparency at a value greater than the first transparency when the first difference is greater than or equal to a first predetermined value, and
superimposing the first transparent image on the second transparent image.

7. The image generation method according to claim 1, further comprising:
acquiring a third image that is an image of a third frame following the second frame; and
generating a second superimposed image that is a result of superposition of the first superimposed image and the third image.

8. The image generation method according to claim 7,
wherein generating the first superimposed image further includes
generating a first transparent image by performing transparency processing on the first image based on first transparency,
generating a second transparent image by performing the transparency processing on the second image based on second transparency different from the first transparency, and
superimposing the first transparent image and the second transparent image on each other, and
generating the second superimposed image further includes
generating a third transparent image by performing the transparency processing on the third image based on third transparency different from the first and second transparency, and
superimposing the first superimposed image and the third transparent image on each other.

9. The image generation method according to claim 8, further comprising:
performing the transparency processing on the second image based on the second transparency lower than the first transparency,
superimposing the second transparent image on the first transparent image,
performing the transparency processing on the third image based on the third transparency lower than the second transparency, and
superimposing the third transparent image on the first superimposed image.

10. The image generation method according to claim 8, further comprising:
before generating the first superimposed image,
calculating a first difference that is a difference between the first image and the second image,
setting the second transparency at a value smaller than the first transparency when the first difference is greater than or equal to a first predetermined value, and
superimposing the second transparent image on the first transparent image, and
before generating the second superimposed image,
calculating a second difference that is a difference between the second image and the third image,
setting the third transparency at a value smaller than the second transparency when the second difference is greater than or equal to a second predetermined value, and
superimposing the third transparent image on the first superimposed image.

11. The image generation method according to claim 8, further comprising:
performing the transparency processing on the second image based on the second transparency higher than the first transparency,
superimposing the first transparent image on the second transparent image,
performing the transparency processing on the third image based on the third transparency higher than the second transparency, and
superimposing the first superimposed image on the third transparent image.

12. The image generation method according to claim 8, further comprising:
before generating the first superimposed image,
calculating a first difference that is a difference between the first image and the second image,
setting the second transparency at a value greater than the first transparency when the first difference is greater than or equal to a first predetermined value, and
superimposing the first transparent image on the second transparent image, and
before generating the second superimposed image,
calculating a second difference that is a difference between the second image and the third image,
setting the third transparency at a value greater than the second transparency when the second difference is greater than or equal to a second predetermined value, and
superimposing the first superimposed image on the third transparent image.

13. An image display apparatus comprising:
at least one processor that
acquires a first image that is an image of a first frame,
acquires a second image that is an image of a second frame following the first frame, and
generates a first superimposed image that is a result of superposition of the first image and the second image; and
a display unit that displays the first superimposed image.

14. The image display apparatus according to claim 13,
wherein the display unit displays the first superimposed image as a still image.

15. The image display apparatus according to claim 13,
wherein the display unit displays the first image and the first superimposed image in sequence.

16. An image display apparatus comprising:
at least one processor that
acquires a first image that is an image of a first frame,
acquires a second image that is an image of a second frame following the first frame,
generates a first superimposed image that is a result of superposition of the first image and the second image,
acquires a third image that is an image of a third frame following the second frame, and
generates a second superimposed image that is a result of superposition of the first superimposed image and the third image; and
a display unit that displays the second superimposed image.

17. The image display apparatus according to claim 16,
wherein the display unit displays the second superimposed image as a still image.

18. The image display apparatus according to claim 16,
wherein the display unit displays the first image, the first superimposed image, and the second superimposed image in sequence.
